(19) United States
(12) Patent Application Publication
(10) Pub. No.: US 2023/0051936 A1
(43) Pub. Date: Feb. 16, 2023

(54) MIXING DEVICE AND MIXING METHOD FOR DISPENSING A MULTI-COMPONENT POLYMERIC MIXTURE

(71) Applicant: PERSICO S.p.a., NEMBRO (IT)

(72) Inventor: Paolo AMBROSINI, NEMBRO (IT)

(73) Assignee: PERSICO S.p.a., NEMBRO (IT)

(21) Appl. No.: 17/758,888

(22) PCT Filed: Dec. 29, 2020
(86) PCT No.: PCT/IT2020/050325

§ 371 Date: Jul. 15, 2022

(30) Foreign Application Priority Data
Jan. 22, 2020 (IT) 102020000001168

(51) Int. Cl. B29B 7/76; B29B 7/80; B29B 7/74

(52) U.S. Cl. CPC B29B 7/7694; B29B 7/805; B29B 7/7636; B29B 7/7404

(57) ABSTRACT

Mixing device (1) for dispensing a multi-component polymeric mixture, comprising a main body (2) comprising a mixing chamber (3) for mixing a first and a second component of the mixture, the mixing chamber having a main development along a longitudinal direction (100) and comprising a respective longitudinal open end (4); a movable body (5) having a central axis (101) with longitudinal development and slidably housed in the main body (2) to alternatively assume, by sliding along the longitudinal direction (100), an occlusion position of the mixing chamber (3) and a mixing position, wherein the movable body (5) comprises a first channel (6) and a second channel (7) each comprising a respective end portion (20) both displaced from the central axis (101) of the movable body (5) and developing substantially along the longitudinal direction (100) up to a longitudinal end face (8) of the movable body (5) facing the open longitudinal end (4) of the mixing chamber (3), wherein the respective end portions (20) of the first (6) and second channel (7) develop inside the movable body (5) or they are made by respectively a first (9) and a second groove (10) obtained on a longitudinal surface (11) of the movable body (5), each groove (9, 10) having development with a component perpendicular to the longitudinal direction (100).

### TECHNICAL FIELD OF THE INVENTION

The present invention relates to a mixing device and to a mixing method for dispensing a liquid or substantially liquid multi-component polymeric mixture, for example a polyurethane mixture.

### STATE OF THE ART

In the context of the production processes of components for the automotive sector, such as for example composite panels for realizing bearing planes, overhead racks, bottoms of cargo beds, etc., it is frequent the use of polyurethane mixtures which, typically in liquid or substantially liquid form, are delivered (e.g. sprayed) onto the component, typically during an intermediate stage of the manufacturing.

In this context it is known using mixing devices for mixing the polyurethane mixture, in jargon called mixing heads, by means of which the polyurethane mixture is firstly made starting from the mixing of the respective base components (typically liquid), such as typically polyol and isocyanate, and subsequently dispensed on the component to be made, for example by spraying.

Known mixing devices typically comprise a main body having an inner cavity of cylindrical shape used as mixing chamber. In the mixing chamber the aforesaid base components are injected at high pressure and in such a way as to obtain a reciprocal interaction between the respective jets, in the jargon called counter-flow injection, in order to achieve their mutual mixing.

In this regard, known mixing devices typically comprise two injection channels, one for each base component, in communication with the mixing chamber by means of respective injection mouths arranged facing each other, to direct the jets of the base components against each other. The mixing chamber finally ends in a respective open end from which the produced polyurethane mixture is dispensed.

Known mixing devices also comprise a movable body, typically of substantially cylindrical shape, slidably housed in the main body to alternatively assume, by sliding along a main development direction of the mixing chamber, an occlusion position, in which it occludes the mixing chamber to preclude the mixing of the base components (physically hindering their injection into the mixing chamber), and a mixing position, in which, typically by moving away from the open end of the mixing chamber, it clears the mixing chamber and it uncovers the injection mouths of the injection channels to allow mixing of the base components.

Known mixing devices typically also comprise two recirculation grooves made on an external surface of the movable body and facing the mixing chamber. With the movable body in the occlusion position, the two recirculation grooves, together with a surface of the main body, form a pair of channels that put each injection channel in hydraulic communication with a respective outlet channel, in turn hydraulically connected to the respective injection channel (e.g. to a tank from which the respective injection channel draws). In this way, even in the non-operative phases of the device, a recirculation of the base components is maintained, to prevent them from reticulating, and/or solidifying, and occluding the respective injection channel.

With the movable body in the mixing position, each recirculation groove is decoupled from the respective injection mouth, interrupting the recirculation of the base components, which are instead directly injected into the mixing chamber and made to interact with each other (e.g. to collide with each other) to achieve their mixing.

The movable body also comprises at least one end portion proximal to the open end of the mixing chamber, counter-shaped to the mixing chamber to completely encumber (with restricted geometric tolerances) a section of the chamber on a plane perpendicular to the main development direction of the chamber. In this way, the movable body is typically also used to clean the mixing chamber by mechanical scraping during its displacement from the mixing position to the occlusion position (during which it typically moves towards the open end of the mixing chamber).

In the use of the known mixing devices, a further component may also be provided, typically a nozzle, arranged downstream of the mixing chamber with respect to a dispensing direction of the mixture and in hydraulic communication with the mixing chamber itself The nozzle is typically structured for dispensing the mixture by spraying through a jet having desired features (e.g. a shape substantially laminar, conical, etc.), to facilitate and/or improve the spraying operation itself, for example as a function of the process to be performed, the geometry of the product to be made, etc.

Document U.S. Pat. No. 4,053,283A describes a mixing device for mixing multi-component plastic materials comprising a mixing chamber to which feeding ducts for the components lead and in which a piston can alternatively assume a retracted position and an advanced position, wherein the piston is provided with an axial duct for the inlet of air into the mixing chamber together with the components.

### SUMMARY OF THE INVENTION

According to the Applicant, the known mixing devices have some drawbacks and/or can be improved in one or more aspects.

For example, the air inlet duct described in U.S. Pat. No. 4,053,283A involves disadvantages both under a functional and a constructive point of view.

First of all, the Applicant believes that the axial positioning of the duct interposes the gas flow, exiting the duct, between the jets of the base components, potentially creating a barrier effect that interferes with the injection of the components and that can hinder their mixing (e.g. pushing the components towards the chamber outlet limiting the mutual interaction of the respective jets when just injected). This phenomenon can involve the dispensing of an unfinished mixture, with undesirable drawbacks in the use of the mixing device, such as for example a waste or reworking of the components sprayed with this mixture, and/or an inefficient use of resources, and therefore an overall increase in the production costs.

The Applicant has also experimentally verified that the axial duct, despite the continuous introduction of air into the mixing chamber both during the mixing phase and during the (typically subsequent) cleaning phase, is subject to occlusion by the components and/or by the mixture.

The occlusion of the axial duct causes frequent downtimes for the cleaning and/or replacement of the piston in which the duct is made, which affect the times and/or the efficiency of the mixture dispensing processes, thus leading to a corresponding increase in the costs (e.g. of production and/or maintenance).

The Applicant has also found that if the passage for the feeding of air is made by one or more grooves obtained in the piston, as described in U.S. Pat. No. 4,053,283A, these grooves can penalize the cleaning operation of the mixing chamber by mechanical scraping by means of the piston. In fact, a groove with axial development prevents the mechanical scraping action of the piston on the surface of the mixing chamber at the groove itself. In this area, the Applicant has observed that the action of the gas flow may not be sufficient to prevent the accumulation or the removal of the residues of the components and/or of the mixture due to frequent use of the mixing device, as typically occurs in industrial field.

The Applicant has therefore posed the problem of mixing and dispensing a multi-component polymeric mixture (e.g. a polyurethane mixture) to ensure a correct and complete mixing of the base components of the mixture and to avoid or reduce interventions for cleaning of the device.

According to the Applicant, the above problem is solved by a mixing device for dispensing a multi-component polymeric mixture according to the attached claims and/or having one or more of the following features.

According to an aspect the invention relates to a mixing device for dispensing a multi-component polymeric mixture. The device comprises:
a main body comprising a mixing chamber for mixing (at least) a first and a second component of said mixture; said mixing chamber having a main development along a longitudinal direction and comprising a respective longitudinal open end;
a movable body having a central axis with longitudinal development and slidably housed in said main body to alternatively assume, by sliding along said longitudinal direction, an occlusion position, in which it occludes said mixing chamber to preclude a mixing of said first and second component of said mixture, and a mixing position, in which it clears said mixing chamber to allow said mixing of said first and second component of said mixture.

Preferably said movable body comprises a first channel and a second channel each comprising a respective end portion extending substantially along said longitudinal direction up to a longitudinal end face of said movable body facing said longitudinal open end of the mixing chamber.

Preferably said respective end portions of the first and second channel are both displaced from said central axis of the movable body.

Preferably said respective end portions of the first and second channel develop inside said movable body or they are made by respectively a first and a second groove obtained on a longitudinal surface of said movable body, each groove having development with a component perpendicular to said longitudinal direction.

By ‘longitudinal’ it is meant parallel to the longitudinal direction.

By ‘perpendicular’, unless otherwise specified, it is meant perpendicular to the longitudinal direction.

By ‘central axis’ it is meant the axis passing through the geometric centres of the sections (or in general of the envelopes of the sections) of the movable body perpendicular to the longitudinal direction.

By ‘development substantially along the longitudinal direction’ it is meant a development having at least one respective main component parallel to the longitudinal direction.

According to the Applicant, the aforementioned pair of channels displaced, at least in the end portion, from the central axis of the movable body, allow introducing a gas flow into the mixing chamber which is not interposed between the jets of the base components of the mixture.

In this way it is eliminated the barrier effect caused by the gas flow and therefore the interference of the latter with the injection of the base components, thus facilitating the correct mixing.

The positioning of the end portions of the first and second channel displaced from the central axis of the movable body allows to increase the section of the channels with respect to an axial positioning of a single channel, as in the prior art. In fact, the Applicant has realized that, as the section of a single axial channel progressively increases, the minimum thickness of the separation septum between the channel and the recirculation grooves progressively decreases (the axial position of the channel is in fact interposed between the recirculation grooves typically present on the surface of the movable body), with consequent structural weakening of the movable body. This fact places a limit on the maximum diameter of the axial channel.

According to the present invention, the channels displaced from the central axis are located in a region of the movable body having greater available section with respect to the axial position.

The Applicant has experimentally verified that a greater flow section of the first and of the second channel facilitates the introduction of the gas into the mixing chamber, for example by limiting the pressure drops, and/or it increases the gas flow entering the mixing chamber for a given operating pressure, and at the same time it prevents the obstruction of each channel caused by the base components and/or by the mixture. Furthermore, the Applicant has realized that such greater section allows to make the channels in a technologically simple way (e.g. by means of cheap tools and/or procedures), with consequent reduction of the respective costs. Furthermore, the aforementioned channels allow an effective and complete cleaning by scraping of the surfaces of the mixing chamber by means of the movable body.

In the case of inner channels, the surface of the movable body used for mechanical scraping of the mixing chamber is not altered, which therefore results, in section, counter-shaped to the mixing chamber.

In the case of the grooves with development with a component perpendicular to the longitudinal direction (i.e. not purely longitudinal), the wall of each groove, during the displacement of the movable body from the mixing position to the occlusion position, completely scrapes also the longitudinal portion of the surface of the mixing chamber which is swept by the mouth of the groove on the end face of the movable body during such displacement. In the comparative case of groove with purely longitudinal development, the aforementioned longitudinal portion of the surface of the mixing chamber (which coincides with the longitudinal portion of surface facing the groove when the movable body is in the occlusion position) would not be scraped by the movable body, with consequent accumulation of residues.

Furthermore, the Applicant has verified that the aforementioned channels limit the accumulation of residues on the longitudinal end face of the movable body, and/or they can also favour its cleaning.

In the case of the inner channels there are in fact two respective outlet mouths of the gas flow which are arranged in advantageous position to favour the detachment and/or to limit the accumulation of residues on the end face itself thanks to the action of the gas flows.

In the case of the grooves with development with a perpendicular component, without limiting to any theory, it is believed that the gas flow, although exiting each channel at substantially perimetral regions of the end face, is suitably directed by the grooves to achieve whirling motions and/or turbulences inside the mixing chamber which exert a cleaning action also of the end face.

The present invention in one or more of the above aspects may have one or more of the following preferred features.

Typically said movable body is (substantially, for example apart from the channels) cylindrical and said central axis coincides with a central symmetry axis of the movable body. Typically said mixing chamber is substantially counter-shaped to said movable body, preferably to an envelope of said movable body (e.g. neglecting any grooves present).

Preferably said respective end portions of the first and second channel are arranged at sides diametrically opposite to each other with respect to said central axis of the movable body. In this way the action of the gas flow exiting the two channels is balanced.

Preferably said respective end portions of the first and second channel developing inside said movable body develop (substantially) entirely along a straight path, more preferably parallel to said longitudinal direction. In this way the realization of the channels, for example by drilling, is simplified.

Preferably said development with a component perpendicular to the longitudinal direction is a helical development, more preferably with axis coinciding with said central (symmetry) axis. In this way the grooves adapt to the cylindrical surface of the movable body.

In one embodiment said first and second channel develop inside said movable body for a whole longitudinal dimension of said movable body, more preferably parallel to said longitudinal direction. In other words, the first and the second channel are completely internal to the movable body and are longitudinally passing through the movable body. In this way both the realization of the channels by drilling and the introduction of the gas flow into each channel, for example by means of a chamber in which the gas flow is conveyed under pressure and in which at least one longitudinal end portion of the movable body opposite the open end of the mixing chamber is movably inserted, are simplified.

In one embodiment said first and second channel each comprise a respective inlet groove obtained on said longitudinal surface of said movable body connected (more preferably contiguous) to said respective end portion and arranged at longitudinally opposite side with respect to said longitudinal end face. In the case the end portions of the first and second channel develop inside the movable body, these end portions develop from the longitudinal end face of the movable body to these inlet grooves, following, for example, a straight path inclined with respect to the longitudinal direction or an L-shaped path (with a tract perpendicular to the longitudinal direction).

Preferably said inlet grooves have rectilinear longitudinal development. In this way each first and second channel made by groove has globally smaller perpendicular (e.g. circumferential) extension and this facilitates the positioning of the groove onto the movable body (which also has the recirculation grooves).

In one embodiment (for example when said first and second channel comprise at least partially a groove) said device comprises a first and a second feeding duct obtained in said main body and ending at said longitudinal surface of the movable body in communication with respectively said first and second channel. In this way it is possible to feed the gas flow to the two channels, limiting the workings performed in and/or on the movable body (e.g. in comparative case of the feeding portions described below).

Preferably said first and second feeding duct communicate with said inlet grooves of respectively said first and second channel. In this way, thanks to the respective longitudinal inlet groove, each channel maintains the coupling with the respective feeding duct in a simple way even against the longitudinal displacement of the movable body.

In one embodiment (for example when said first and second channel coincide with said respective end portions respectively made by said first and second groove, i.e. they are devoid of longitudinal inlet grooves) said first and second feeding duct have a respective feeding end mouth facing the movable body in communication with respectively said first and second groove and having perpendicular development (e.g. circumferential about said central axis) with amplitude equal to a perpendicular development of a projection on a perpendicular plane of (at least) a tract of respectively said first and second groove (e.g. said tract having longitudinal length equal to an excursion of said movable body between said occlusion and mixing positions). In this way it is possible to keep each feeding duct coupled to the respective groove during the longitudinal displacement of the movable body, even against a groove entirely with development with perpendicular component (e.g. helical).

In one embodiment in which the end portions of the channels are made by said first and second groove, said first and second channel comprise a respective feeding portion which develops inside said movable body substantially along the longitudinal direction, more preferably parallelly to said longitudinal direction, away from said longitudinal end face of the movable body and at longitudinally opposite side of the movable body with respect to said first and second groove. In this way the feeding portions remain in communication with the first and second groove, to feed them with the gas flow, during the displacement of the movable body along the longitudinal direction.

Preferably said first and second channel coincide in a single feeding portion at said respective feeding portions, the single feeding portion more preferably developing along said central axis of the movable body. In this way it is sufficient to drill a single hole to feed both the grooves.

In such embodiment, the first and second channel each comprise a respective connecting duct between said respective feeding portion (or the single feeding portion) and said first and second groove (or said respective inlet groove) respectively, each connecting duct having development with at least one perpendicular component (more preferably purely perpendicular). In this way the feeding portions are put in communication with the grooves in a simple way.

In one embodiment in which the end portions of the channels are made by means of said first and second groove, said first and second channel comprise a respective feeding portion made by a respective feeding groove obtained on said longitudinal surface of said movable body, each feeding groove developing away from said longitudinal end face of the movable body and at longitudinally opposite side of the movable body with respect to said first and second groove up to a longitudinal end of the movable body opposite to said longitudinal end face of the movable body. In this way, in addition to keeping the feeding portions in communication with the first and second groove during the movement of the movable body, the manufacturing of the movable body is simplified.

Typically said device comprises, for each of said first and second component, a respective injection channel and a respective outlet channel obtained in said main body.

Typically the movable body comprises a first and a second recirculation groove made on said longitudinal surface of the movable body at diametrically opposite positions with respect to the central axis of the movable body to set in hydraulic communication, when the movable body is in the occlusion position, a respective injection channel-outlet channel pair (to put in recirculation said first and second component respectively). Typically, the recirculation grooves develop along a respective rectilinear path parallelly to the longitudinal direction.

Preferably said connecting ducts are in a more distal position from said longitudinal end face of the movable body with respect to said first and second recirculation groove. In this way the section of each feeding portion (or of the single feeding portion) is not limited by the presence of the recirculation grooves. In this way it is facilitated the passage of the gas flow.

Preferably each end portion of said first and second channel when internal to said movable body, or each inlet groove, is angularly arranged about said central axis of the movable body with an angle greater than or equal to 70°, more preferably greater than or equal to 80°, and less than or equal to 110°, more preferably less than or equal to 100°, for example equal to 90°, with respect to (each of) said recirculation grooves. In this way these elements are arranged in positions substantially angularly equidistant from the recirculation grooves to distribute substantially uniformly on the movable body the manufacturing (e.g. milling and/or drilling) performed on the latter in order to facilitate its realization and/or limit the structural weakening of the movable body. In this way, moreover, when the inlet grooves are present, by moving away the passage regions of the base components and of the gas flow respectively, the probability of a possible leakage of the components of the mixture towards the first and second channels is reduced.

Preferably, when said movable body is in said occlusion position, said longitudinal end face of the movable body is located at, more preferably lies (substantially) on a same plane, of said longitudinal open end of the mixing chamber. In this way, during the displacement from the mixing position to the occlusion position, the movable body travels entirely through the mixing chamber to clean it.

According to an aspect the invention relates to a mixing method for dispensing a multi-component polymeric mixture. The method comprises:
arranging the mixing device according to the present invention;
conveying a gas flow into said first and second channel;
while keeping said gas flow active in said first and second channel:
placing said movable body in said mixing position, mixing in said mixing chamber said first and second component of said multi-component polymeric mixture in order to make said multi-component polymeric mixture, and dispensing said multi-component polymeric mixture through said longitudinal open end of said mixing chamber; and subsequently
moving said movable body to said occlusion position to clean said mixing chamber by mechanical scraping of said movable body and action of said gas flow.

Preferably said method comprises keeping said gas flow active for a (substantially) whole time interval in which said movable body is in said occlusion position, more preferably as long as said first and second component of said mixture are under pressure in a respective injection channel (and therefore they are in recirculation in the respective recirculation groove). In this way, in case the end portions of the first and second channel are respectively made by the first and second groove or the inlet grooves are present, it is further reduced the risk that the basic components of the mixture, during their recirculation along the recirculation grooves, can leak, by pressure gradient, between the movable body and the surface of the mixing chamber towards one or both the first and second groove, and occlude the passages used for the gas flow.

### BRIEF DESCRIPTION OF THE DRAWINGS

The features and the advantages of the present invention will be further apparent by the following detailed description of some embodiments, presented by way of non-limiting example of the present invention, with reference to the attached figures, in which:

FIG. 1 shows a perspective view of a partial longitudinal section of a first embodiment of the mixing device according to the present invention;

FIG. 2 shows a front view of the partial longitudinal section of FIG. 1 with the movable body in the mixing position;

FIG. 3 shows a perspective and partial section view of a portion of the movable body of the mixing device of FIG. 1;

FIG. 4 shows a front view of a perpendicular section along the plane 300 of the mixing device of FIG. 1;

FIG. 5 shows a perspective view of a partial longitudinal section of a second embodiment of the mixing device according to the present invention;

FIG. 5a shows a front view of a detail of a perpendicular section along the plane 200 of the mixing device of FIG. 5;

FIG. 6 shows a front view of a longitudinal section of a third embodiment of the mixing device according to the present invention;

FIG. 7 shows a front view of a longitudinal section of a fourth embodiment of the mixing device according to the present invention.

### DETAILED DESCRIPTION OF SOME EMBODIMENTS OF THE INVENTION

In the present description and figures the same reference number is used for the same elements, also in their different constructive variants.

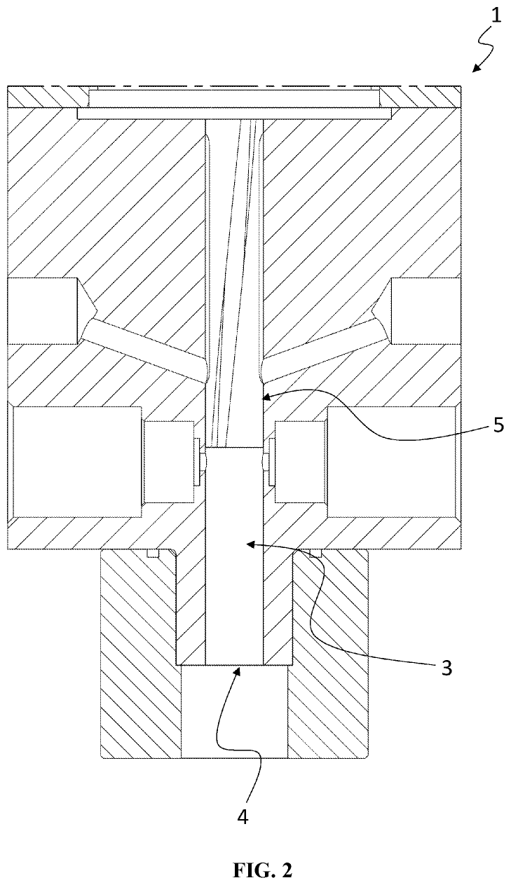

In the figures, number 1 globally indicates a mixing device for dispensing a multi-component polymeric mixture (not shown). Exemplarily the device 1 comprises a main body 2 comprising a mixing chamber 3 (FIG. 2) for mixing a first and a second component of the mixture (not shown, typically polyol and isocyanate so that the obtained mixture is a polyurethane mixture, e.g. a polyurethane foam).

Exemplarily the mixing chamber 3 has a main development along a longitudinal direction 100 and it comprises a respective longitudinal open end 4.

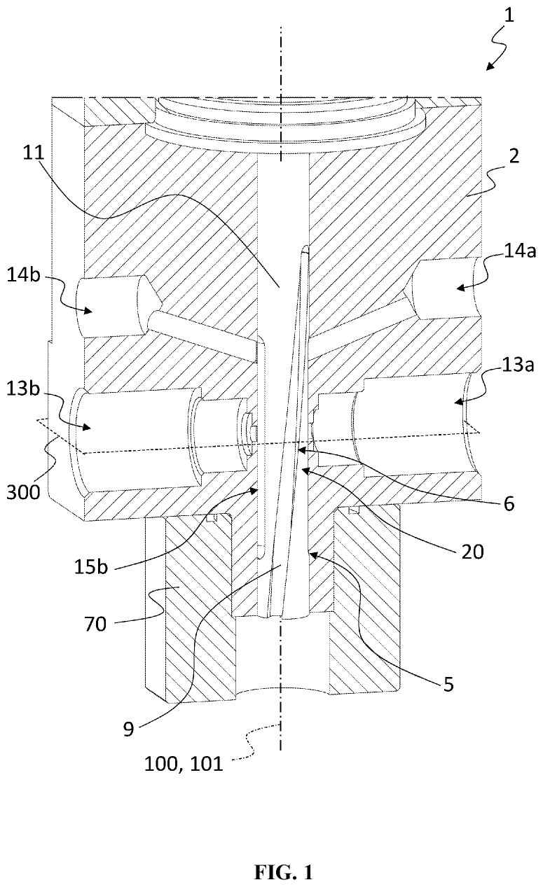

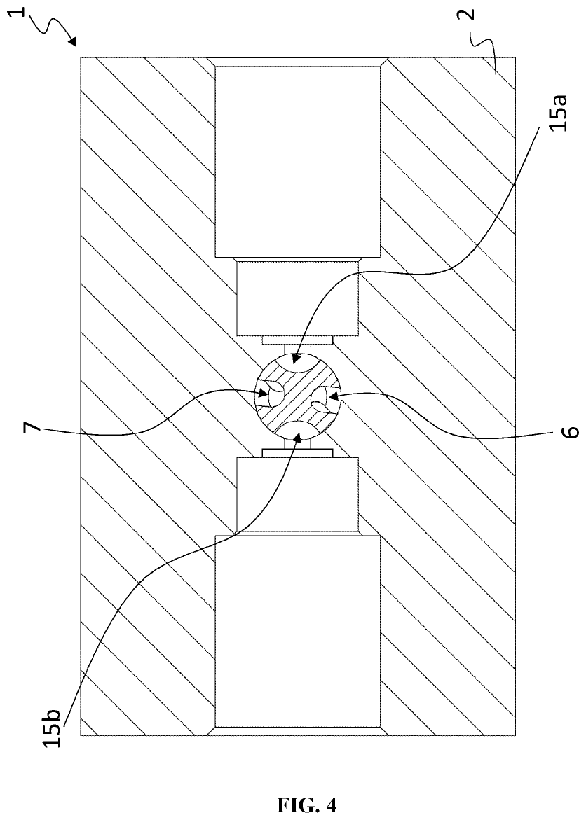

Exemplarily the device 1 comprises a substantially cylindrical movable body 5 having a central axis 101 with longitudinal development (exemplarily coinciding with the longitudinal direction 100) and slidably housed in the main body to alternatively assume, by sliding along the longitudinal direction 100, an occlusion position (e.g. shown in FIGS. 1, 4, 5, 5a, 6 and 7), in which it occludes the mixing chamber 3 to preclude a mixing of the first and second component of the mixture, and a mixing position (e.g. shown in FIG. 2), in which it clears the mixing chamber 3 to allow the mixing of the first and second component of the mixture. Exemplarily the central axis 101 is a central symmetry axis of the movable body 5.

Exemplarily the mixing chamber 3 is substantially counter-shaped to an envelope of the movable body 5 (e.g. neglecting possible grooves present), i.e. it is cylindrical.

Exemplarily the device 1 comprises, for each first and second component, a respective injection channel 13a, 13b and a respective outlet channel 14a, 14b obtained in the main body 2. Exemplarily the movable body 5 comprises a first 15a and a second recirculation groove 15b made on a longitudinal surface 11 of the movable body at diametrically opposite positions with respect to the central axis 101 of the movable body and extending along a respective purely longitudinal straight path. Exemplarily the recirculation grooves put in hydraulic communication, when the movable body is in the occlusion position, a respective injection channel-outlet channel pair.

Exemplarily the movable body 5 comprises a first channel 6 and a second channel 7 each comprising a respective end portion 20 developing substantially along the longitudinal direction 100 up to a longitudinal end face 8 of the movable body 5 facing the longitudinal open end 4 of the mixing chamber 3, wherein exemplarily the respective end portions 20 of the first 6 and second channel 7 are both displaced from the central axis 101 of the movable body and they are arranged at sides diametrically opposite to each other with respect to the central axis 101 of the movable body 5.

In a first embodiment, as exemplarily shown in figures from 1 to 4, the end portions 20 of the first 6 and second channel 7 are exemplarily made by a first 9 and a second groove 10 respectively obtained on the longitudinal surface 11 of the movable body 5, each groove 9, 10 having a respective helical development (e.g. with constant pitch) with axis coinciding with the central axis 101 of the movable body. In one alternative embodiment, the first and the second groove can have any development with a perpendicular component (e.g. not necessarily helical, but for example arc development extending on the longitudinal surface of the movable body).

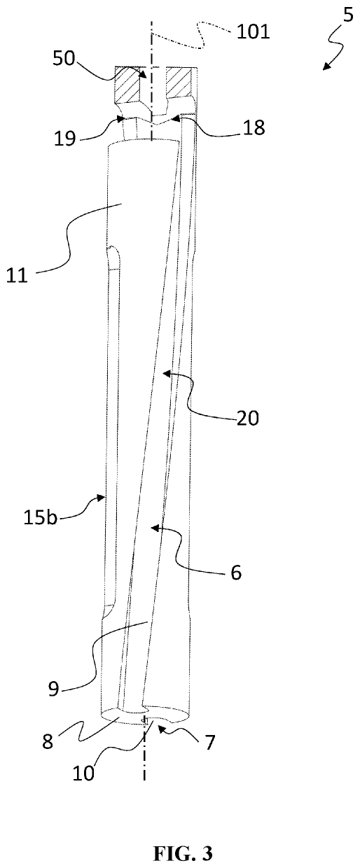

Preferably the first 6 and second channel 7 comprise a respective feeding portion 50 which develops inside the movable body 5 parallelly to the longitudinal direction 100, away from the longitudinal end face 8 of the movable body and at longitudinally opposite side of the movable body with respect to the first 9 and second groove 10. Exemplarily (FIG. 3) the first 6 and second channel 7 at the respective feeding portions coincide in a single feeding portion 50 (only partially shown), developing along the central axis 101 of the movable body. In an alternative embodiment not shown, the feeding portions of the first and second channel are distinct and separate from each other.

Exemplarily (FIG. 3) the first 6 and second channel 7 each comprise a respective connecting duct 18, 19 between the respective (not shown), or the single, feeding portion 50 and respectively the first 9 and second groove 10, each connecting duct 18, 19 having a purely perpendicular development.

Exemplarily the connecting ducts are in a more distal position from the longitudinal end face 8 of the movable body with respect to the first 15a and second recirculation groove 15b so that the section of each, or of the single, feeding portion is not limited by the presence of the recirculation grooves (facilitating the passage of the gas flow).

In one alternative embodiment, (not shown) instead of the feeding portions made in the movable body as described above, the device comprises a first and a second feeding duct obtained in the main body and ending at the longitudinal surface of the movable body in communication with the first and second channel respectively. In this embodiment, the first and the second channel therefore coincide with the respective end portions made respectively by the first and second (helical) groove. In this embodiment, the first and second feeding ducts comprise a respective feeding end mouth facing the movable body in communication with the first and second groove respectively and having a circumferential development about the central axis of the movable body having a width equal to a perpendicular development of a projection on a perpendicular plane of a tract of respectively the first and second groove having a longitudinal length equal to an excursion of the movable body between the occlusion and mixing positions. In fact, given the development with a perpendicular component of the grooves, the portion of each groove instantaneously at, and in communication with, the respective feeding duct (i.e. with the respective feeding end mouth) undergoes a circumferential displacement about the central axis of the movable body during the longitudinal displacement of the movable body. The feeding end mouths, thanks to their circumferential development as described above, therefore always remain in communication with the respective groove for the whole longitudinal excursion of the movable body.

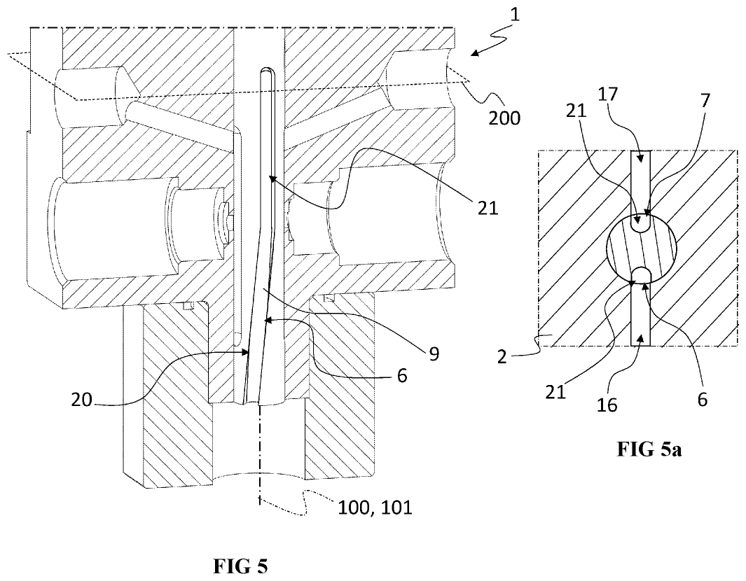

In a second embodiment, as exemplarily shown in FIGS. 5 and 5a, the end portions 20 of the first 6 and second channel 7 are made by respectively a first 9 and a second groove 10 obtained on the longitudinal surface 11 of the movable body 5, each groove 9, 10 having a respective helical development with axis coinciding with the central axis 101 of the movable body. Exemplarily the first 6 and second channel 7 each comprise a respective inlet groove 21 contiguous to the respective end portion 20 and arranged at longitudinally opposite side with respect to the longitudinal end face 8, the inlet groove being obtained on the longitudinal surface 11 of the movable body and exemplarily having rectilinear longitudinal development.

In the second embodiment, as shown in FIG. 5a, the device 1 comprises a first 16 and a second feeding duct 17 obtained in the main body 2 and ending at the longitudinal surface 11 of the movable body 5 in communication with the inlet grooves 21 of respectively the first 6 and second channel 7 to allow the communication between each duct and the respective groove against the longitudinal displacement of the movable body, without the need to circumferentially widen the feeding end mouth beyond the width of the respective groove, as in the embodiment described above.

In one embodiment alternative to the second embodiment (not shown), the first and second channel can comprise, instead of the feeding ducts 16 and 17, a respective feeding portion which longitudinally develops inside the movable body (as discussed with reference to FIG. 3).

In a further embodiment (not shown) the feeding portions of the first and second channel can in turn be made, instead of by means of an internal passage as discussed above with reference to FIG. 3, by a respective feeding groove obtained on the longitudinal surface of the movable body, developing away from the longitudinal end face of the movable body and at longitudinally opposite side of the movable body with respect to the first and second groove. The feeding grooves can, for example, develop up to a longitudinal end (not shown) of the movable body, opposite the end face 8, which is movably inserted into a chamber into which the gas is pressurized (to create a pair of passages of the gas).

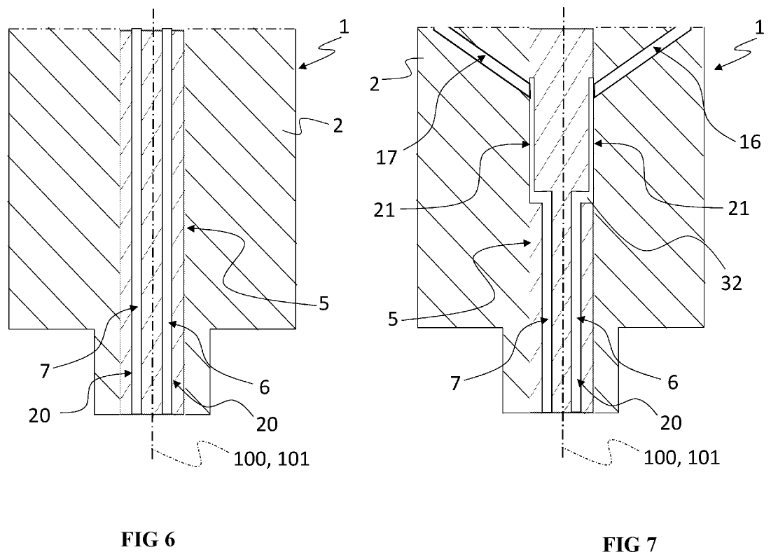

In a third embodiment, as exemplarily shown in FIG. 6, the first 6 and second channel 7 exemplarily develop entirely inside the movable body 5 along a rectilinear path parallel to the longitudinal direction 100 and (not shown) for a whole longitudinal dimension of the movable body (i.e. the first and second channel are completely internal to the movable body and they are longitudinally passing through the movable body). In the third embodiment, the subdivision of the first and second channel into the respective end portions 20 and into the respective feeding portions 50 is purely arbitrary.

In the fourth embodiment shown in FIG. 7, exemplarily the respective end portions 20 of the first 6 and second channel 7 develop inside the movable body 5 and the first 6 and second channel 7 each comprise a respective inlet groove 21 obtained on the longitudinal surface 11 of the movable body and connected to the respective end portion, arranged at longitudinally opposite side with respect to the longitudinal end face and having a longitudinal rectilinear development (for example in a similar way to the second embodiment). Exemplarily the first and the second channel develop from the longitudinal end face 8 of the movable body up to a point on the longitudinal surface (i.e. the lateral surface) of the movable body, following an L-shaped path (with a respective tract 32 perpendicular to the longitudinal direction to connect each end portion 20 with the respective inlet groove 21). In a variant embodiment not shown, the first and second channel can extend, from the longitudinal end face 8 to the respective inlet groove 21, along a rectilinear path inclined with respect to the longitudinal direction.

In the fourth embodiment (for example in a similar way to the second embodiment) the device 1 exemplarily comprises a first 16 and a second feeding duct 17 obtained in the main body 2 and ending at the longitudinal surface of the movable body in communication with the inlet grooves 21 of the first and second channel respectively.

Exemplarily each inlet groove 21 (shown for the second embodiment in FIG. 5, not shown for the fourth embodiment), and each end portion 20 of the first 6 and second channel 7 internal to the movable body (third and/or fourth embodiment, not shown), is angularly arranged about the central axis 101 of the movable body with an angle equal to 90° with respect to each recirculation groove 15a, 15b.

In use, the mixing device 1 allows to perform a mixing method for dispensing a multi-component polymeric mixture, for example during a step of manufacturing of composite panels for applications in the automotive field.

Preferably the mixing device 1 is firmly fixed to an end of a robotic arm (e.g. a robotic arm with at least five axes, not shown) in order to be easily moved in the space for dispensing the mixture easily and/or with accuracy on a desired substrate.

Initially, it is exemplarily provided conveying the gas flow in the first 6 and second channel 7. Subsequently, with the movable body 5 in the occlusion position, it is exemplarily provided pushing under pressure the first and second components (not shown) into the respective injection channels to make them recirculate, by means of the recirculation grooves 15a and 15b, towards the respective outlet channels (in turn connected in closed loop to the respective injection channels, not shown).

At this point the device is ready to mix the components and dispense (e.g. by spraying) the obtained mixture.

Thus exemplarily, keeping the gas flow active in the first and second channel, it is provided placing the movable body in the mixing position, to mix in the mixing chamber 3 the first and second component of the multi-component polymeric mixture in order to make the multi-component polymeric mixture, and dispensing the multi-component polymeric mixture through the longitudinal open end 4 of the mixing chamber 3.

Exemplarily (FIGS. 1 and 2) the device comprises a nozzle 70 arranged downstream of the mixing chamber and shaped (not shown) to give to the dispensed mixture a jet having, for example, a laminar shape, advantageous for covering with the obtained mixture large surfaces of the substrate even with a few coats of the mixing device. The gas flow introduced into the mixing chamber through the first 6 and the second channel 7 exemplarily contributes to the dispensing of the mixture by spraying.

Subsequently, once ended the phase of spraying of the substrate, it is exemplarily provided, keeping the gas flow active in the first and second channel, moving the movable body to the occlusion position to clean the mixing chamber 3 by mechanical scraping of the movable body 5 and action of the gas flow. Exemplarily when the movable body is in the occlusion position, the longitudinal end face 8 of the movable body lies on a same plane of the longitudinal open end 4 of the mixing chamber so that the movable body, in its longitudinal displacement, entirely travels the mixing chamber to clean it.

Exemplarily the method comprises keeping the gas flow active for a whole time interval in which the movable body is in the occlusion position, preferably as long as the first and second component of the mixture are under pressure in the respective injection channel (and therefore they are in recirculation in the respective recirculation groove). In the embodiments which provide for channels totally internal to the movable body, keeping active the gas flow facilitates, for example, the cleaning of the mixing chamber. In the embodiments that provide for the first and second grooves, and/or channels having the respective inlet groove 21, keeping active the gas flow, in addition to facilitating cleaning, reduces the risk that the components can leak, due to pressure gradient, between the movable body 5 and the surface of the mixing chamber 3 towards one or both the first and second groove, and/or the inlet grooves, and occlude the passages used for the gas flow.

What is claimed is:

1. Mixing device for dispensing a multi-component polymeric mixture, the device comprising:
a main body comprising a mixing chamber for mixing at least a first and a second component of the mixture; the mixing chamber having a main development along a longitudinal direction and comprising a respective longitudinal open end;
a movable body having a central axis with longitudinal development and slidably housed in the main body to alternatively assume, by sliding along the longitudinal direction, an occlusion position, in which it occludes the mixing chamber to preclude a mixing of the first and second component of the mixture, and a mixing position, in which it clears the mixing chamber to allow the mixing of the first and second component of the mixture, wherein
the movable body comprises a first channel and a second channel each comprising a respective end portion extending substantially along the longitudinal direction up to a longitudinal end face of the movable body facing the longitudinal open end of the mixing chamber,
wherein the respective end portions of the first and second channel are both displaced from the central axis of the movable body, and
wherein the respective end portions of the first and second channel are made by respectively a first and a second groove obtained on a longitudinal surface of the movable body, each groove having development with a component perpendicular to the longitudinal direction or wherein the respective end portions of the first and second channel develop inside the movable body.

2. The device according to claim 1, wherein the development of each groove is a helical development, preferably with axis coinciding with the central axis, or wherein the respective end portions of the first and second channel developing inside the movable develop entirely along a straight path parallel to the longitudinal direction.

3. The device according to claim 1, wherein the respective end portions of the first and second channel are arranged at sides diametrically opposite to each other with respect to the central axis of the movable body.

4. The device according to claim 1, wherein the first and second channel develop inside the movable body for a whole longitudinal dimension of the movable body.

5. The device according to claim 1, wherein the first and second channel each comprise a respective inlet groove obtained on the longitudinal surface of the movable body connected to the respective end portion and arranged at longitudinally opposite side with respect to the longitudinal end face of the movable body, wherein the inlet grooves have rectilinear longitudinal development.

6. The device according to claim 5, comprising a first and a second feeding duct obtained in the main body and ending at the longitudinal surface of the movable body in communication with respectively the first and second channel, wherein the first and second feeding duct communicate with the inlet grooves of respectively the first and second channel.

7. The device according to claim 1, wherein the first second channel comprise a respective feeding portion which develops inside the movable body substantially along the longitudinal direction away from the longitudinal end face of the movable body and at longitudinally opposite side of the movable body with respect to the first and second groove, wherein the first and second channel coincide in a single feeding portion at the respective feeding portions, wherein the first and second channel each comprise a respective connecting duct between the single feeding portion and the first and second groove respectively, each connecting duct having development with at least one perpendicular component.

8. The device according to claim 1, wherein the first and second channel comprise a respective feeding portion made by a respective feeding groove obtained on the longitudinal surface of the movable body, each feeding groove developing away from the longitudinal end face of the movable body and at longitudinally opposite side of the movable body with respect to the first and second groove up to a longitudinal end of the movable body opposite to the longitudinal end face of the movable body.

9. The device according to claim 7, comprising, for each of the first and second component, a respective injection channel and a respective outlet channel obtained in the main body, and a first and a second recirculation groove made on the longitudinal surface of the movable body at diametrically opposite positions with respect to the central axis of the movable body to set in hydraulic communication, when the movable body is in the occlusion position, a respective injection channel-outlet channel pair, wherein the connecting ducts are in a more distal position from the longitudinal end face of the movable body with respect to the first and second recirculation groove.

10. The device according to claim 1, wherein each end portion of the first and second channel when internal to the movable body, or each inlet groove, is angularly arranged about the central axis of the movable body with an angle greater than or equal to 70°, and less than or equal to 110°, with respect to each of the recirculation grooves.

11. Mixing method for dispensing a multi-component polymeric mixture, the method comprising:
arranging the mixing device according to claim 1;
conveying a gas flow into the first and second channel;
while keeping the gas flow active in the first and second channel:
placing the movable body in the mixing position, mixing in the mixing chamber the first and second component of the multi-component polymeric mixture in order to make the multi-component polymeric mixture, and dispensing the multi-component polymeric mixture through the longitudinal open end of the mixing chamber; and subsequently
moving the movable body to the occlusion position to clean the mixing chamber by mechanical scraping of the movable body and action of the gas flow,
wherein the method comprises keeping the gas flow active for a substantially whole time interval in which the movable body is in the occlusion position.

12. The device according to claim 1, wherein the first and second channel develop parallelly to the longitudinal direction.

13. The device according to claim 7, wherein the single feeding portion develops along the central axis of the movable body.
